(19) United States
(12) Patent Application Publication
(10) Pub. No.: US 2007/0107578 A1
(43) Pub. Date: May 17, 2007

(54) Adjustable cutting die mounting assembly

(76) Inventor: Kevin W. Koelsch, Toledo, OH (US)

Correspondence Address: BRINKS HOFER GILSON & LIONE, P.O. BOX 10395, CHICAGO, IL, 60610, US

(21) Appl. No.: 11/274,631

(22) Filed: Nov. 15, 2005

(51) Int. Cl. B26D 1/56

(52) U.S. Cl. 83/698.61; 83/343

(57) ABSTRACT

An adjustable cutting die mounting system includes at a least pair of securable and releasable two axis mounting and securement assemblies. Each assembly includes a square or rectangular opening in the cutting die board which receives an opposed pair of slotted brackets or guides which are secured to the die within the opening. The slotted brackets cooperatively receive an elongate member which defines an elongate slot. The elongate slot receives a captive mounting bolt which adjustably secures the cutting die board to the drum cutting die drum.

### TECHNICAL FIELD

The invention relates generally to mounting devices for rotary cutting dies and more specifically to an adjustable mounting assembly for facilitating two axis adjustment as well as ready securement of a cutting die to a rotary die cutting drum.

### BACKGROUND OF THE INVENTION

Solid, laminated or corrugated fiberboard, cardboard sheet stock, corrugated plastics, vinyl's, felts, cloth, automotive sound deadening materials and thin, other planar, non-metallic materials may be cut, slit, perforated or scored into regular or irregular shapes to form, for example, inserts, carton blanks, panels, separators and advertising displays. The resulting blanks are stored and shipped flat or utilized in their desired shapes or folded and secured at the point of use. Rotary die cutting machines represent the preferred means for cutting, slitting, perforating and scoring such non-metallic materials. These machines include an upper drum or cylinder to which is secured a rotary steel rule die board having serrated or continuous blades or rules which compress the stock against a lower, contra-rotating anvil which is covered with a stiffly resilient covering. Such rotary steel rule cutting dies are capable of providing complexly configured cut, scored, perforated and slit blanks at high production rates with exceptionally good dimensional accuracy.

The standard rotary die cutting machine includes a cylinder or drum having a diameter varying from about 7 inches (17.8 cm.) to about 26 inches (66 cm.) which provides correspondingly varying cutting lengths. The die drum includes a plurality of rows of equally spaced, threaded bolt holes which receive complementarily threaded fasteners which are utilized to secure large, complementarily curved wooden die boards containing the steel cutting rules.

In recent years, such rotary die cutting machines have been combined on the same production line with flexographic printing presses. The combination achieves equally impressive production capability including both multiple color printing and cutting, scoring and slitting in a single pass, continuous flow operation on fiberboard, cardboard or other planar stock.

One problem that has accompanied the shift to the unitary printing and cutting production line is that downtime of either machine for service, reconfiguration or adjustment amounts to downtime for both machines. Thus, there is significant financial incentive to undertake and perfect apparatus and processes which facilitate rapid changeover, adjustment and repair of these machines. The high production rates of these machines also encourages any attempt to minimize downtime and maximize production time.

### BRIEF SUMMARY OF THE INVENTION

An adjustable cutting die mounting system includes at a least pair of securable and releasable two axis mounting and securement assemblies. Each assembly includes a square or rectangular opening in the cutting die board which receives an opposed pair of slotted brackets or guides which are secured to the die within the opening. The slotted brackets cooperatively receive an elongate member which defines an elongate slot. The elongate slot receives a captive mounting bolt which adjustably secures the cutting die board to the cutting die drum.

Thus it is an object of the present invention to provide an adjustable cutting die board mounting system.

It is a further object of the present invention to provide adjustable mounting components for facilitating adjustment and securement of cutting die boards on the drum of a rotary die cutting machine.

It is a still further object of the present invention to provide an adjustable cutting die mounting system which facilitates both two axis adjustment and securement of the cutting die board to a rotary cutting die drum.

It is a still further object of the present invention to provide an adjustable cutting die mounting system which includes a pair of opposed slotted guides which receive an elongate slotted member therein.

Further objects and advantages of the present invention will become apparent by reference to the following description of the preferred embodiment and appended drawings wherein like reference numbers refer to the same component, element or feature.

### BRIEF DESCRIPTION OF THE DRAWINGS

FIG. 1 is a perspective view of a rotary cutting die board in place on a rotary die cutting machine drum incorporating the present invention;

FIG. 2 is a perspective view of the components of an adjustable rotary cutting die board mounting system according to the present invention;

FIG. 3 is a fragmentary, end elevational view of a portion of the adjustable die board mounting system according to the present invention;

FIG. 4 is a top plan view of the slide portion of an adjustable cutting die mounting system according to the present invention;

FIG. 5 is a full, sectional view of a captive mounting bolt assembly and slide according to the present invention taken along line 5-5 of FIG. 2; and

FIG. 6 is a full, sectional view of a captive mounting bolt assembly and slide according to the present invention taken along line 6-6 of FIG. 5.

### DETAILED DESCRIPTION OF THE INVENTION

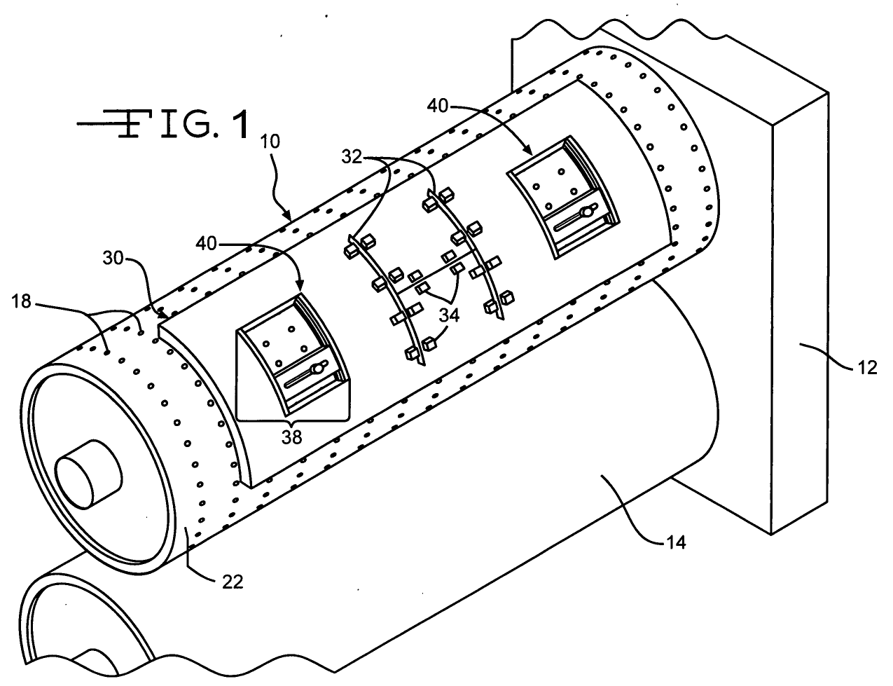

Referring now to FIG. 1, a rotary die cutting cylinder or drum is illustrated and generally designed by the reference number 10. The rotary die cutting cylinder or drum 10 may reside in a dedicated die cutting machine 12 or may be a portion of a two-stage printing and die cutting machine such as that illustrated in FIG. 1 of U.S. Pat. No. 6,109,158 which is hereby incorporated by reference. The rotary die cutting cylinder or drum 10 is disposed adjacent and parallel to a contra-rotating anvil 14. The anvil 14 is covered with a layer or coating of a rugged, stiffly resilient material. Both the die cutting drum 10 and the contra-rotating anvil 14 are driven by a suitable synchronous drive assembly disposed within the machine 12.

The die cutting cylinder or drum 10 is an elongate cylinder having a plurality of threaded apertures 18 disposed on an exterior surface 22. The diameter of the drum 10 may vary from approximately 7 inches (17.8 cm) to 26 inches (66 cm). A common diameter for the drum 10 is 20 inches (50.8 cm) and the threaded apertures 18 are arranged in circumferential lines or columns at 26 equally spaced locations which encircle the drum 10. Smaller diameter drums 10 will typically utilize fewer apertures 18 in each circumferential column and vice versa. These lines or columns of apertures 18 are most commonly spaced apart 2 inches (5.08 cm) transversely, i.e., axially, across the drum 10.

Installed upon the cutting die cylinder or drum 10 is a cutting die board or assembly 30 which extends axially and circumferentially upon and about the drum 10. The cutting die board or assembly 30 includes a desired pattern of creasing, perforating, scoring or, as illustrated, cutting rules 32 which achieve a desired creased, perforated, scored or cut line or pattern of lines in a product. It will be appreciated that the shape and size of the cutting rules 32 illustrated is merely exemplary and representative and that the cutting rules 32 and the entire cutting die assembly 30 may vary widely and take any necessary and desired configuration. Typically, a plurality of resilient stripper pads 34 are arranged adjacent one or both sides of the cutting rules 32 and assist release of planar stock (not illustrated) as it passes through the machine 12 between the cutting die drum 10 and the anvil 14.

Disposed within suitably sized square or rectangular openings or cut-outs 38 in the cutting die board or assembly 30 are preferably a pair of adjustable mounting assemblies 40. While typically two mounting assemblies 40 will provide appropriate and sufficient mounting security and integrity, depending upon the size of the cutting die board or assembly 30, it is expected and anticipated that three or four mounting assemblies 40 may be utilized with larger die cutting assemblies 30. For example, more than two mounting assemblies 40 may be utilized with a cutting die assembly 30 that extends circumferentially around the drum 10 to or substantially near the nominal circumferential limit of 180°.

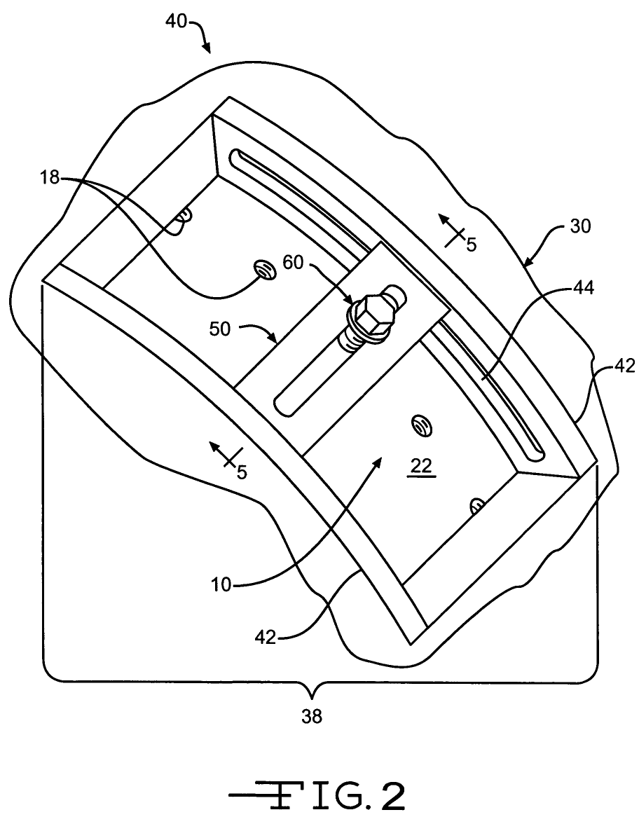

Referring now to FIGS. 2 and 3, an adjustable mounting assembly 40 according to the present invention is illustrated. The mounting assembly 40 includes a pair of opposed, symmetrically arranged left and right arcuate brackets or guides 42 which extend circumferentially along and about the surface 22 of the drum 10. Each of the guides 42 includes a correspondingly arcuate slot or recess 44 having rounded, i.e., semi-circular, ends. Disposed within the arcuate slot 44 and extending through chamfered apertures 46 into the cutting die assembly or board 30 are a plurality of fasteners 48 such as wood screws or other tightly securable but removable fasteners.

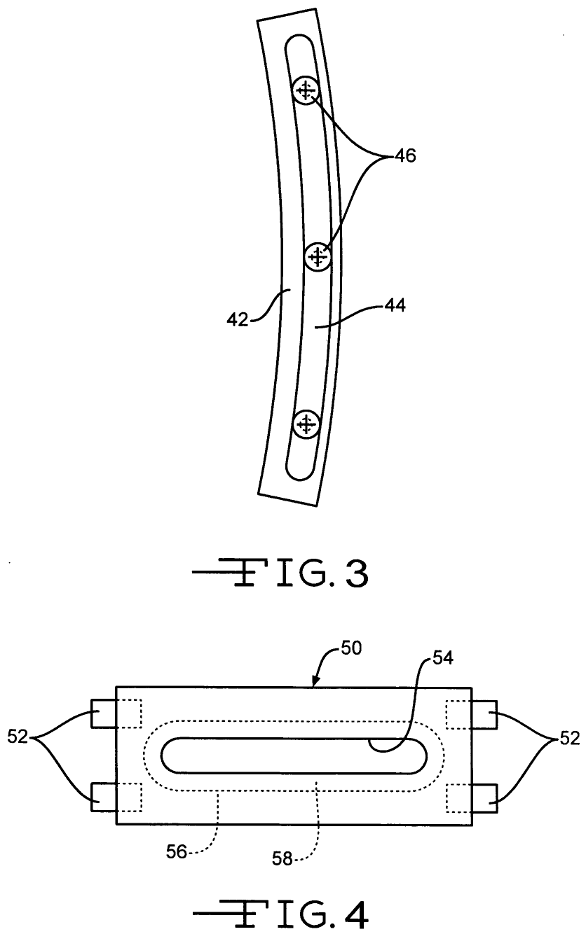

As illustrated in FIGS. 2 and 4, received within the opposed slots or recesses 44 of the brackets or guides 42 in the cutting die assembly 30 is a rectangular, elongate slide block 50. The elongate slide block 50 includes pairs of pegs or register pins 52 on each of its short ends which have a diameter equal to or just slightly less than the width of the slots or recesses 44 in the arcuate guides 42. The pegs or pins 52 are received within the slots or recesses 44 and thus the slide block 50 is movable circumferentially about the drum 10 within the guides 42 and the cutting die assembly 30. The rectangular slide block 50 defines a first, smaller, i.e., narrower and shorter, elongate slot 54 on its upper or outer surface and a second, longer and wider slot 56 on its lower or inner surface which forms a shoulder 58 with the first, smaller slot 54.

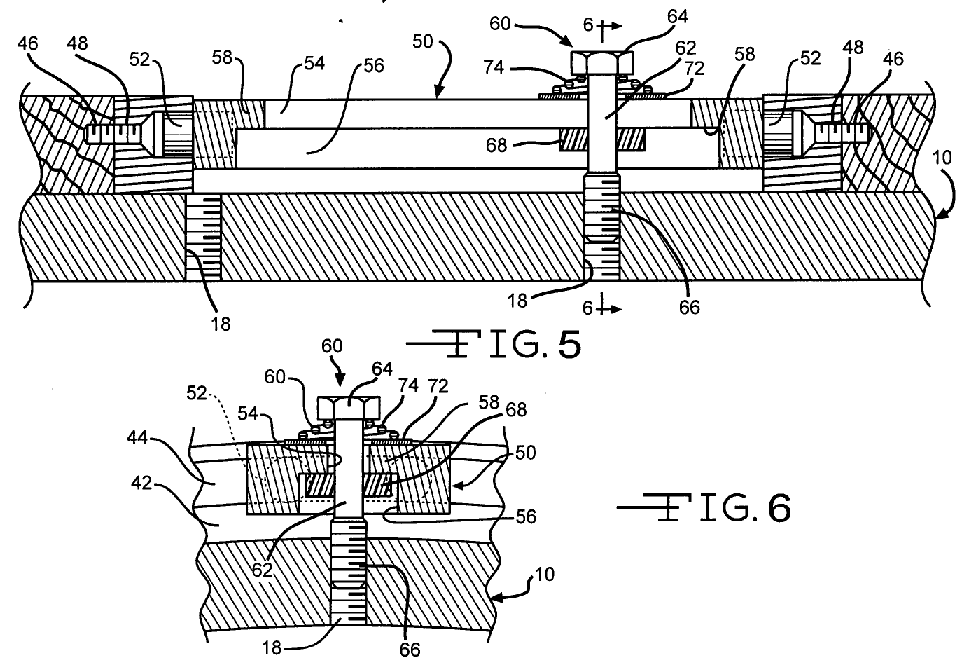

Referring now to FIGS. 5 and 6, the first elongate slot 54 of the slide block 50 receives a captive bolt assembly 60 including a machine bolt 62 having a conventional hex or square head 64. Alternatively, the head 64 of the bolt 62 may define a hexagonal socket adapted to receive an Allen wrench or other configuration such as a square socket or other internal or external configuration engageable by a complementary driver. The machine bolt 62 may include rolled threads 66 having a diameter larger than the diameter of the shank of the bolt 62. Alternatively, the threads 66 may be cut. The male rolled or cut threads 66 are complementary to the female threads in the apertures 18 on the cutting die drum assembly 10. The threads 66 assist retention of a stiffly flexible washer 68 which resides about the shank of the bolt 62. The flexible washer 68 may be fabricated of nylon or other stiffly resilient flexible material such as high durometer rubber or other elastomer. It will be appreciated, however, that the threads 66 may be either rolled or cut into the shank of the bolt 62 as the resiliency and flexibility of the washer 68 which functions as a retaining device to maintain the bolt 62 within the elongate slot 54 of the slide block 50 and rests against the shoulder 58 will function with either style of thread. This is achieved by an interference fit between the inside diameter of the resilient washer 68 and the outside diameter of the bolt 62. Slidably disposed along the upper surface of the slide block 50 is a flat washer 72 which receives the shank of the bolt 62. Between the upper surface of the flat washer 72 and the bolt head 64 is a conical compression spring 74. The conical compression spring 74 biases the bolt 62 in a radially outward direction from the cutting die drum assembly 10 and, as noted, the flexible washer 68 retains the bolt 62 within the elongate slot 54.

In operation and use, at least two mounting assemblies 40 are disposed within a cutting die board or assembly 30 by cutting appropriate rectangular openings or cutouts in the cutting die board or assembly 30 in locations remote from the positions of the steel rule cutting, perforating and scoring dies 32. The slide block 50 having a captive fastener assembly 60 is positioned within the two arcuate brackets or guides 42, this assembly is inserted into the cutout in the cutting die assembly 30 and the fasteners 46 are inserted and tightened into the cutting die assembly 30.

Next, the entire cutting die assembly 30 is placed upon a rotary die cutting cylinder or drum 10 and the bolts 62 are threaded into complementarily threaded passageways 18 on the drum 10 with the cutting die assembly 30 located approximately as desired on the rotary cutting die cylinder or drum 10. Finally, the cutting die assembly 30 is moved axially (transversely) and circumferentially on the surface 22 of the rotary cutting die cylinder or drum 10 until the steel rule cutting dies 32 and the die board or assembly 30 are properly located relative to the drum 10 and the stock passing through the machine 12 resulting in properly registered and located slitting, scoring, perforating or cutting of the planar stock.

It will be appreciated that both initial adjustment as just described and adjustment to compensate for shifts of registration during operation can be readily achieved by loosening the bolts 62, sliding the cutting die assembly 30 upon the surface 22 of the rotary cutting die drum 10, such bi-axial, i.e., XY, movement being permitted and facilitated by interaction of the mounting bolts 62 in the elongate slot 54 and motion of the sliding blocks 50 in the slots 44 of the arcuate guides 42.

Release and removal of the cutting die assembly 30 is equally rapid and straightforward as it entails simply loosening of the bolts 62 sufficiently to allow removal of the cutting die board or assembly 30 from the rotary cutting die cylinder or drum 10. It will be appreciated that the bolts 62 remain captive within the slots 54 of the slide blocks 50 by virtue of the flexible washers 68 disposed about the shanks of the machine bolts 62.

It should be appreciated that although the invention has been described with the guides or brackets 42 disposed circumferentially on the drum or cylinder 30, and the slide blocks 50 disposed axially, the guides or brackets 42 may be disposed axially and the slide blocks 50 disposed circumferentially about the drum 30 if appropriate changes are made to these components, i.e., the brackets or guides 42 are straightened and the slide blocks 50 are curved to mimic the curvature of the die board or assembly 30.

The foregoing disclosure is the best mode devised by the inventor for practicing this invention. It is apparent however, that devices incorporating modifications and variations will be obvious to one skilled in the art of rotary die cutting apparatus. Inasmuch as the foregoing disclosure presents the best mode contemplated by the inventors for carrying out the invention and is intended to enable any person skilled in the pertinent art to practice this invention, it should not be construed to be limited thereby but should be construed to include such aforementioned obvious variations and be limited only by the spirit and scope of the following claims.

1. An adjustable cutting die board mounting assembly comprising, in combination,
a cutting die board having a steel rule and at least two rectangular cutouts, each of said cutouts having an adjustable mount;
each of said adjustable mounts comprising a pair of opposed guides each defining an elongate recess and including means for attachment to said cutting die board, a slide block having pins received in said recesses and defining an elongate slot, and
a bolt assembly received within said elongate slot, said bolt assembly including a threaded fastener having a head and a threaded portion.

2. The adjustable mounting assembly of claim 1, wherein said means for attachment to said cutting die board are wood screws.

3. The adjustable mounting assembly of claim 3, further including a compression spring disposed between said slide block and said head of said fastener and means for retaining said fastener in said elongate slot of said slide block.

4. The adjustable mounting assembly of claim 3, wherein said means for retaining includes a flexible washer.

5. The adjustable mounting assembly of claim 1, wherein said threaded fastener includes rolled threads.

6. The adjustable mounting assembly of claim 1, wherein said guides and recesses are arcuate.

7. The adjustable mounting assembly of claim 1, wherein said compression spring is conical.

8. An adjustable mounting assembly for rotary cutting die boards comprising, in combination,
a pair of spaced-apart elongate guides, each of said guides defining an elongate recess and including means for securing said guides to a rotary cutting die board;
a slide block disposed between said guides and including opposed pairs of pins received within said recesses and an elongate slot; and
a bolt assembly disposed within said elongate slot of said sliding block, said bolt assembly including a head and means for retaining said machine bolt in said elongate slot of said slide block.

9. The die mounting assembly of claim 8 further including a compression spring disposed between said head and said slide block and a flat washer disposed between said spring and said slide block.

10. The die mounting assembly of claim 8, wherein said means for retaining said guides are wood screws.

11. The die mounting assembly of claim 8, wherein said means for retaining includes a flexible washer.

12. The die mounting assembly of claim 8, wherein said flexible washer is fabricated of nylon.

13. The die mounting assembly of claim 8, wherein said threaded fastener includes rolled threads.

14. The die mounting assembly of claim 8, wherein said compression spring is conical.

15. An adjustable mounting assembly for rotary cutting die boards comprising, in combination,
a pair of spaced-apart elongate guides, each of said guides defining an elongate recess;
a slide block disposed between said guides and including guide means extending from said block and received within said recesses and an elongate slot; and
a captive bolt assembly disposed within said elongate slot of said slide block, said captive bolt assembly including a threaded bolt having a head, a compression spring disposed between said head and said slide block and means for retaining said machine bolt in said elongate slot of said slide block.

16. The adjustable mounting assembly of claim 15, wherein said means for retaining includes a flexible washer.

17. The adjustable mounting assembly of claim 16, wherein said flexible washer is fabricated of nylon.

18. The adjustable mounting assembly of claim 15, wherein said threaded fastener includes rolled threads.

19. The adjustable mounting assembly of claim 15, wherein said guides and recesses are arcuate.

20. The adjustable mounting assembly of claim 15, wherein said compression spring is conical.
